(19) United States
(12) Patent Application Publication
(10) Pub. No.: US 2010/0068557 A1
(43) Pub. Date: Mar. 18, 2010

(54) Plain Bearing Composite Material, Use Thereof and Production Methods Therefor

(76) Inventor: Gerd ANDLER, Bad Schwalbach (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/914,360

(22) PCT Filed: May 13, 2006
(86) PCT No.: PCT/EP2006/004507

§ 371 Date: Jun. 2, 2008

(30) Foreign Application Priority Data
May 13, 2005 (DE) 10 2005 023 306.6

(51) Int. Cl. B32B 15/01; B32B 15/20; C21D 1/26; B32B 15/18

(52) U.S. Cl. 428/677; 148/532; 148/518

(57) ABSTRACT

The invention relates to a plain bearing composite material with a supporting layer made of steel, a bearing metal layer made of a copper alloy, and with a lining applied to the bearing metal layer. The copper alloy can contain 0.5 5% by weight of nickel, 0.2 to 2.5% by weight of silicon and=0.1% by weight of lead. The lining can be a sputtered layer that is applied without an intermediate layer. The invention also relates to methods for producing this composite material.

### RELATED APPLICATIONS

This application is related to other applications filed on the same date herewith under attorney docket numbers 710100-039 (based on PCT/EP/2006/004505), 710100-040 (based on PCT/EP2006/004515), and 710100-041 (based on PCT/EP/2006/004517).

### BACKGROUND OF THE INVENTION

1. Technical Field

The invention relates to a plain bearing composite material. The invention further relates to a use thereof and production methods therefor.

2. Related Art

Known from DE 44 15 629 C1 is the use of a copper-nickel-silicon alloy for producing wear-resistant objects with emergency running properties such as, for example, cast pistons for pressure casting machines. The alloy described in DE 44 15 629 C1 consists of 1-4% nickel, 0.1-1.5% silicon and with the remainder being copper, and is used as a solid material.

U.S. Pat. No. 2,137,282 describes an alloy comprising 0.1-30% nickel, 0.05-3% silicon and the remainder copper. Following appropriate heat treatment, this alloy is distinguished by high hardnesses and good electrical conductivities.

U.S. Pat. No. 1,658,186 describes a copper-nickel-silicon alloy, where silicides acting as hard particles are discussed in detail. Various heat treatment methods are also specified for adjusting the hardness.

Another copper-nickel-silicon alloy is found in U.S. Pat. No. 2,241,815 where the nickel fraction is 0.5-5% and the silicon fraction is 0.1-2%.

U.S. Pat. No. 2,185,958 describes alloys comprising 1% nickel, 3.5% silicon and the remainder copper, as well as 1.5% silicon and 1% nickel and the remainder copper.

DE 36 42 825 C1 discloses a plain bearing material comprising 4 to 10% nickel, 1-2% aluminium, 1-3% tin and the remainder copper as well as the usual impurities, which should have a high strength and long lifetime. Solid material bushings are produced from this plain bearing material.

GB 2384007 describes a plain bearing composite material with a steel back on which a sintered layer of a copper alloy is applied, having a maximum hardness of 130 HV. The copper alloy comprises 1-11 wt. % tin, up to 0.2 wt. % phosphorus, maximum 10 wt. % nickel or silver, maximum 25 wt. % lead and bismuth.

Plain bearing composite materials in which a lining is sputtered onto a bearing metal layer are provided with intermediate layers of nickel, of a nickel alloy, of nickel-chromium, of zinc or of a zinc alloy as described in DE 43 28 921 A1. If a Cu alloy is used as the bearing alloy and if an Sn-containing alloy is used for the uppermost layer, the Sn then diffuses in the course of time into the Cu alloy, thus reducing the Sn content of the uppermost layer. At the same time, a brittle CuSn compound is formed at the compound surface, thus reducing the binding strength. In view of this, the intermediate layer of Ni or an Ni alloy is formed on the bearing alloy by spraying on or sputtering or by electro-plating. The uppermost layer is then formed by vapour deposition, whereby a more stable bond can be obtained.

Diffusion barrier layers are also mentioned in DE 28 53 774.

DE 195 25 330 describes a layer material in which a bearing material is sputtered directly onto a supporting material. A steel supporting metal can be used as the supporting material to which the bearing material can be applied without an intermediate layer. However, it is also possible to use a copper-containing supporting material, in particular a supporting material comprising a copper-lead-tin alloy. For example, the supporting material can consist of CuPb22Sn.

If the lead fraction in the supporting material is of the order of magnitude of the lead fraction in the bearing material, there is no concentration gradient or only a small concentration gradient between the two materials, so that no diffusion processes can take place between the bearing material and the supporting material. If the supporting material has a higher lead concentration than the bearing material, the migration of lead to the surface of the bearing material is additionally promoted. The copper-lead-tin alloy forming the supporting material can be clad onto a steel supporting metal by casting.

### SUMMARY OF THE INVENTION

It is the object of the invention to provide a plain bearing composite material with sputtered-on linings, which is comparable to the known composite material with regard to its strength and tribological properties, where diffusion barrier layers can be dispensed with regardless of the composition of the lining. It is also an object to provide a use and production methods.

### DETAILED DESCRIPTION

It has been found that in the claimed copper alloys with nickel and silicon fractions, these components are diffusion-inhibiting, in particular they act on aluminium and tin so that almost no diffusion occurs. Slight diffusion can never be excluded but in this case, only an extremely thin intermediate layer is formed which does not lead to peeling of the lining applied to the copper alloy.

It has been shown that copper alloys with nickel-silicon can be adjusted over a wide range with regard to their mechanical and tribological properties so that it is possible to adapt to the required properties.

As a result of its stiffness, the steel back ensures the required press fit so that the structure of the bearing material can be adjusted independently of the strength requirements. The claimed copper alloys can thus be configured, for example, with regard to their structure so that they lie in a comparable range to the classical lead-bronze bearings regarding their strength and hardness as well as their tribological properties such as corrosion behaviour.

Overall the area of usage of the plain bearing composite material is substantially extended.

The composite materials with steel backs also have advantages in applications with steel housings as a result of their coefficient of thermal expansion.

The tribological properties of the bearing metal are preferably adjusted by a thermo-mechanical treatment, in particular by rolling and annealing.

Such thermo-mechanical treatment of the composite material can be configured in such a manner that the properties of the steel required for the finished part are not impaired.

According to a first alternative, the production method according to the invention comprises the following process steps:

Producing strip material from a copper-nickel-silicon alloy and cladding by rolling the strip material on a supporting layer of steel to produce a composite. In this case, the bearing metal and/or steel is deformed by 50-70%.

The subsequent thermo-mechanical treatment comprises the following steps:

a first annealing of the composite at 550° C. to 700° C. for 2 to 5 hours, at least one first rolling of the composite, wherein a degree of deformation of 20-30% is implemented,

at least one second annealing at 500° C.-600° C. for >1 h,

optionally a second rolling of the composite, where a maximum degree of deformation of 30% is implemented, followed by a third annealing at temperatures >500° C. for at least 1 h.

According to a further alternative, the copper alloy is applied to the supporting layer and is sintered or cast-on. The yield point of the bearing metal is adjusted by means of the first or the second rolling step in combination with the subsequent annealing, where the yield point of the bearing metal is preferably 150 to 250 MPa.

If the final dimension has been reached after the second annealing, the thermo-mechanical treatment is ended. In this case, the yield point is adjusted by the first rolling and the second annealing.

If the final dimension has not yet been achieved after the second annealing, this is followed by the second rolling and a third annealing step, whereby the yield point is adjusted to the specified value.

The structure after the thermo-mechanical treatment is distinguished by fine, uniformly isotropically distributed intermetallic NiSi-based precipitations within the copper matrix.

Said yield point of the bearing metal lies significantly below that of steel, which is possible because the steel supporting layer provides the required press fit here. The advantage of the composite materials according to the invention is that the yield point of the bearing metal can be lowered so far until the desired tribological properties, in particular the adaptability of the bearing metal layer, are achieved, i.e. that for example no wear or only slight wear of the counter-running part occurs.

Sheet bars are separated from the composite to produce plain bearing elements following coil slitting and the sheet bars are deformed by known deforming steps to form plain bearing elements. The final process is preferably the machining of the plain bearings and the application of the lining.

The lining is applied by means of a PVD process, in particular sputtering. Optionally, a lead-in layer is also applied to the lining.

The tribological properties of the composite material are further improved by the lining.

In the copper-nickel-silicon alloy, the nickel fraction is 0.5-5 wt. %, preferably 1.0 to 3.0 wt. %, in particular 1.5 to 2.2 wt. % and the silicon fraction is 0.2-2.5 wt. %, preferably 0.4 to 1.2 wt. % or 0.5 to 1.5 wt. %.

The copper-nickel-silicon alloy can contain 0.05-2.0 wt. % manganese, preferably 0.15-1.5 wt. %.

It has been shown that if the weight ratio of nickel to silicon is between 2.5 and 5 (nickel: silicon=2.5 to 5), the tribological properties can be improved, in particular corrosion of the bearing material can be reduced significantly. With these weight ratios the nickel-silicon compounds responsible for the good tribological properties are favoured and formed in sufficient measure.

The copper alloys can contain further micro-alloying elements. The supporting layer preferably contains 0.05-0.4 wt. %, preferably 0.075 to 0.25 wt. % of at least one micro-alloying element. Possible micro-alloying elements are, for example, chromium, titanium, zirconium, zinc and magnesium, individually or in combination.

Preferably a compound clad by rolling exists between the bearing metal layer and the supporting layer optionally via an intermediate layer. Copper or a copper alloy such as, for example, a copper-zinc alloy or a copper-tin alloy can be used for the intermediate layer.

The bearing metal layer can also be a sintered layer or a cast layer, where sintering temperatures between 600° C. and 800° C. over 10-30 min or casting temperatures of 1000° C. to 1250° C. are used. A first annealing is integrated in the sintering process.

Sputtered layers preferably consist of an aluminium-tin alloy, aluminium-tin-silicon alloy, aluminium-tin-copper alloy, aluminium-tin-silicon-copper alloy or an aluminium-tin-nickel-manganese alloy.

In these alloys, the tin fraction is preferably 8-40 wt. %, the copper fraction 0.5-4.0 wt. %, the silicon fraction 0.02-5.0 wt. %, the nickel fraction 0.02-2.0 wt. % and the manganese fraction 0.02-2.5 wt. %.

It has been shown that no brittle phases which lead to peeling of the lining are formed with these sputtered layers in combination with the claimed copper alloys. An intermediate layer can thus be dispensed with, whereby considerable cost savings are achieved.

The thickness of the bearing metal layer is preferably 0.1-0.8 mm, preferably 0.1-0.5 mm, in particular 0.15-0.35 mm.

The thickness of the lining is preferably 4-30 μm, preferably 8-20 μm, in particular 10-16 μm.

The thickness of the lead-in layer is 0.2-12 μm, preferably 0.2 to 6 μm, in particular 0.2 to 3 μm.

Preferred uses of plain bearing composite materials are those for plain bearing shells.

Exemplary copper alloys are:

TABLE 1
(values in wt. %)

| | Example | | | | |
|---|---|---|---|---|---|
| | 1 | 2 | 3 | 4 | 5 |
| Ni | 1.9 | 1.5 | 0.8 | 3.8 | 2.8 |
| Si | 0.6 | 0.5 | 0.25 | 1.2 | 0.8 |
| Mn | 0.15 | 0.05 | 0.05 | 0.1 | 0.05 |
| Pb | <0.1 | <0.1 | <0.1 | <0.1 | <0.1 |
| Cr | | 0.15 | | | 0.15 |
| Ti | | | | 0.15 | |
| Zr | | | 0.2 | | 0.15 |
| Cu | Remainder | Remainder | Remainder | Remainder | Remainder |

An exemplary process provides the following process steps:
continuous casting of a copper alloy, in particular double continuous casting, having a width of 300 mm and a thickness of 10 mm to produce strip material
bilateral milling and subsequent winding of the strip material,
rolling and annealing operations as far as the dimensions for cladding by rolling.

The strip material is mechanically pre-treated, e.g. by brushing, and applied to the steel strip by cladding by means of rolling. The steel strip has a width of 300 mm and a thickness of 4.5 mm. The cladding by rolling with the copper alloy results in a degree of deformation of 50-75%.

This is followed by a first annealing step in a bell-type furnace at 550° C. over 2 hours. A first rolling is then carried out in a rolling step, whereby the thickness of the composite is reduced by 28%, which corresponds to the final dimension.

The composite is then annealed at 550° C. for 2 h. This is followed by coil slitting with dimensions of 95 mm wide×1.56 mm thick.

The yield point of the bearing metal in this example is about 150-170 MPa.

According to a further process variant, the copper alloy is scattered as powder on the steel strip and sintered on by means of at least one sintering process at 680° C. for 10-20 min in a protective gas atmosphere.

According to a further alternative method, the copper alloy is poured at a temperature of 1000° C. to 1250° C. onto the steel strip which is preferably preheated above 1000° C. Cooling then takes to below 100° C. within 1 to 5 min, in particular 2 to 4 min.

The subsequent rolling and annealing steps are the same as in the alternative method of cladding by rolling.

Examples of sputtered layers are given in Table 2

TABLE 2
(values in wt. %)

| | Example | | | | |
|---|---|---|---|---|---|
| | 1 | 2 | 3 | 4 | 5 |
| Al | Remainder | Remainder | Remainder | Remainder | Remainder |
| Sn | 22 | 35 | 25 | 10 | 20 |
| Cu | 0.7 | 1.2 | 0.7 | 0.5 | 0.5 |
| Si | | | 2.5 | | 1.5 |
| Mn | | | | 1.5 | |
| Ni | | | | 0.7 | 0.7 |

All these linings can be combined with bearing metal layers of copper alloys as well as with lead-in layers.

Lead-in layers on these layer combinations can be pure tin or indium layers as well as all said electro-plated and plastic layers, where the lead-in layer is preferably to be selected so that it is softer than the lining used.

1-29. (canceled)

30. A plain bearing composite material with a supporting layer made of steel, a bearing metal layer made of a copper alloy containing 0.5-5 wt. % nickel, 0.2-2.5 wt. % silicon, ≦0.1 wt. % lead and the remainder copper and with a lining applied directly to the bearing metal layer by means of a PVD process.

31. The plain bearing composite material according to claim 30, wherein the copper alloy contains 0.05-2 wt. % manganese.

32. The plain bearing composite material according to claim 1, wherein the weight ratio of nickel to silicon lies between 2.5 and 5.

33. The plain bearing composite material according to claim 1, wherein the bearing metal layer contains 0.05-0.4 wt. % of micro-alloying elements.

34. The plain bearing composite material according to claim 33, wherein the micro-alloying elements are selected from the group consisting of at least one of chromium, titanium, zirconium, zinc or magnesium.

35. The plain bearing composite material according to claim 30, wherein a compound clad by rolling exists between the bearing metal layer and the supporting layer with our without an intermediate layer.

36. The plain bearing composite material according to claim 1, wherein the bearing metal layer is a sintered layer.

37. The plain bearing composite material according to claim 30, wherein the bearing metal layer is a cast layer.

38. The plain bearing composite material according to claim 30, wherein the lining is applied by means of sputtering.

39. The plain bearing composite material according to claim 38, wherein the sputtered layer consists of either an aluminium-tin alloy, aluminium-tin-silicon alloy, aluminium-tin-copper alloy, an aluminium-tin-silicon-copper alloy or an aluminium-tin-nickel-manganese alloy.

40. The plain bearing composite material according to claim 39, wherein in the alloys the tin fraction is 8-40 wt. %, the copper fraction is 0.5-4.0 wt. %, the silicon fraction is 0.02-5.0 wt. %, the nickel fraction is 0.02-2.0 wt. % and the manganese fraction is 0.02-2.5 wt. %.

41. The plain bearing composite material according to claim 30, wherein a lead-in layer is provided on the lining.

42. The plain bearing composite material according to claim 41, wherein the lead-in layer consists of either tin, lead, copper or indium or as a plastic layer.

43. The plain bearing composite material according to claim 30, wherein the thickness of the bearing metal layer is 0.1-0.8 mm.

44. The plain bearing composite material according to claim 30, wherein the thickness of the lining is 4-30 μm.

45. The plain bearing composite material according to claim 41, wherein the thickness of the lead-in layer is 0.2 to 12 μm.

46. The plain bearing composite material according to claim 30 applied to a plain bearing shell.

47. A method for producing plain bearing composite material, in particular for plain bearing elements, such as plain bearing shells, comprising the following process steps:
producing strip material from a copper alloy containing 0.5-5 wt. % nickel, 0.2-2.5 wt. % silicon, wt. % lead and the remainder copper and cladding by rolling the strip material with or without using an intermediate layer on a supporting layer of steel to produce a composite,
thermo-mechanical treatment of the composite comprising the following steps:
at least one first annealing of the composite at 505° C.-700° C. for 2 to 5 hours at least one first rolling of the composite, wherein a degree of deformation of 20-30% is implemented,
at least one second annealing at 500° C.-600° C. for more than 1 h.

48. A method for producing plain bearing composite material, in particular for plain bearing elements, such as plain bearing shells, comprising the following process steps:
applying a copper alloy containing 0.5-5 wt. % nickel, 0.2-2.5 wt. % silicon, ≦0.1 wt. % lead and the remainder copper on a supporting layer of steel to produce a composite,
sintering the composite, wherein a first annealing is integrated in the sintering process,
thermo-mechanical treatment of the composite comprising the following steps:
at least one first rolling of the composite, wherein a degree of deformation of 20-30% is implemented,
at least one second annealing at 500° C.-600° C. for more than 1 h.

49. A method for producing plain bearing composite material, in particular for plain bearing elements, such as plain bearing shells, comprising the following process steps:
pouring a copper alloy containing 0.5-5 wt. % nickel, 0.2-2.5 wt. % silicon, ≦0.1 wt. % lead and the remainder copper onto a supporting layer of steel to produce a composite,
thermo-mechanical treatment of the composite comprising the following steps:
at least one first annealing of the composite at 550° C.-700° C. for 2 to 5 hours
at least one first rolling of the composite, wherein a degree of deformation of 20-30% is implemented,
at least one second annealing at 500° C.-600° C. for more than 1 h.

50. The method according to claim 47, the second annealing is followed by a second rolling with a maximum degree of deformation of 30% with a subsequent third annealing at temperatures >500° C. for at least 1 h.

51. The method according to claim 48, the second annealing is followed by a second rolling with a maximum degree of deformation of 30% with a subsequent third annealing at temperatures >500° C. for at least 1 h.

52. The method according to claim 49, the second annealing is followed by a second rolling with a maximum degree of deformation of 30% with a subsequent third annealing at temperatures >500° C. for at least 1 h.

53. The method according to claim 50, wherein sheet bars are separated from the composite,
that these sheet bars are deformed to give plain bearing elements and
that lining is applied by sputtering.

54. The method according to claim 51, wherein sheet bars are separated from the composite,
that these sheet bars are deformed to give plain bearing elements and
that lining is applied by sputtering.

55. The method according to claim 52, wherein sheet bars are separated from the composite,
that these sheet bars are deformed to give plain bearing elements and
that lining is applied by sputtering.

56. The method according to claim 53, wherein a lead-in layer is applied to the lining after sputtering.

57. The method according to claim 54, wherein a lead-in layer is applied to the lining after sputtering.

58. The method according to claim 54, wherein a lead-in layer is applied to the lining after sputtering.
